(19) United States
(12) Patent Application Publication
(10) Pub. No.: US 2026/0075099 A1
(43) Pub. Date: Mar. 12, 2026

(54) SCHEDULED VIDEO CONFERENCE SURVIVABILITY

(71) Applicant: Zoom Video Communications, Inc., San Jose, CA (US)

(72) Inventors: Patrick John Jensen, Fresno, CA (US); Martin Josef Pagel, Seattle, WA (US); Michael Adrian White, Alpine, UT (US)

(73) Assignee: Zoom Video Communications, Inc., San Jose, CA (US)

(21) Appl. No.: 18/826,357

(22) Filed: Sep. 6, 2024

(51) Int. Cl. H04L 65/1069; H04L 12/18

(52) U.S. Cl. CPC H04L 65/1069; H04L 12/1818

(57) ABSTRACT

Techniques for scheduled video conference survivability are disclosed. In an example method, a computing system receives, from a video conference provider, information about a scheduled video conference scheduled for a first time, the information including a join token and a scheduled video conference identifier. The computing system determines that a network connection to the video conference provider is not available. The computing system publishes the information about the scheduled video conference. The computing system receives, from a client device, a request to join the scheduled video conference including the join token and a video conference identifier. The computing system identifies the first scheduled video conference using the video conference identifier. The computing system joins the client device to the scheduled video conference using the join token.

### FIELD

The present application generally relates to video conferencing administration, and more particularly relates to systems and methods for scheduled video conference survivability.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example system that provides videoconferencing functionality to various client devices, according to some aspects of the present disclosure.

FIG. 2 shows an example system in which a video conference provider provides videoconferencing functionality to various client devices, according to some aspects of the present disclosure.

FIG. 3 shows an example user interface that may be used in some example systems configured for scheduled video conference survivability, according to some aspects of the present disclosure.

FIG. 4 shows an example of a system for providing scheduled video conference survivability, according to some examples of the present disclosure.

FIG. 5 shows another example of a system for providing scheduled video conference survivability, according to some examples of the present disclosure.

FIG. 6 shows an example sequence diagram illustrating a provisioning of scheduled video conference survivability, according to some examples of the present disclosure.

FIG. 7 shows a flowchart of an example method for providing scheduled video conference survivability, according to some examples of the present disclosure.

FIG. 8 shows a flowchart of an example method for providing scheduled video conference survivability, according to some examples of the present disclosure.

FIG. 9 shows an example of a UI as may be used in some example systems for scheduled video conference survivability, according to some aspects of the present disclosure.

FIG. 10 shows another example of a UI as may be used in some example systems for scheduled video conference survivability, according to some aspects of the present disclosure.

FIG. 11 shows an example computing device suitable for use in example systems or methods for providing scheduled video conference survivability, according to some examples of the present disclosure.

### DETAILED DESCRIPTION

Examples are described herein in the context of systems and methods for scheduled video conference survivability. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another.

Video conferencing has emerged as a principal communications channel for organizations, buttressed by the widespread and increasing availability of high-bandwidth network connections. As a result, video conferencing may now be designated as a critical communications channel that will be available even during emergencies, extreme weather conditions, or major Internet outages. Video conferences with some degree of guarantee of availability under such circumstances may be referred to as survivable.

Some video conference providers offer video conferencing services that rely on the video conference provider acting as a central coordination hub, handling aspects of video conferencing such as authentication, scheduling, video and audio streaming, encryption, participant management, and so on. In some cases, video conferencing between client devices cannot be operated without a reliable network connection to the remote video conference provider for all participating client devices.

Consider two client devices connected to the same network, such as a regional wide-area network (“WAN”) controlled by an organization. Using existing systems, to engage in a video conference, the two client devices must communicate via a video conference provider, typically over the Internet. When the video conference provider cannot be reached by one or both client devices but the regional WAN connection remains available, the two client devices nevertheless may not be able to engage in a video conference despite the availability of a network connection between them. Even existing systems that have a degree of survivability for in-progress video conferences may nevertheless lack the capability to enable future, scheduled video conferences that use only resources on the regional WAN. This may be because, even where point to point communications between the two client devices can be established, the two client devices are not configured to provision, allocate, or authorize the network resources needed for video conferencing such as multimedia routers. In such cases, the two client devices may be unable to communicate despite having the resources available to do so.

To address these difficulties, the systems and methods for scheduled video conference survivability according to this disclosure can be used to enable scheduled, survivable video conferences among client devices with network connectivity among themselves but without network connectivity with the video conference provider. The following non-limiting example is provided to introduce certain concepts.

In the example method, a server connected to a regional WAN receives, from a video conference provider, information about a scheduled video conference scheduled for some time in the future. For example, a client device can be used to schedule an upcoming video conference. The time, date, participant list, and so on is sent to the video conference provider, which can then generate the information about the scheduled video conference. The information may include a join token and a scheduled video conference identifier. The join token can be used as a means of authentication to join the scheduled video conference when the video conference provider is not available to provide authentication services.

The server later determines that a network connection to the video conference provider is not available. For example, a natural disaster, civil disturbance, or inclement weather may render the Internet route to the video conference provider unavailable for some or all participants on the participant list.

The server publishes the information about the scheduled video conference. For example, the server may render the information about the scheduled video conference as a web page that is available to the client devices connected to the regional WAN using, for example, network-based authentication. Client devices can access the web page in a web browser to obtain the information. For instance, the information may be encoded in a uniform resource locator (“URL”) that can be used to join the scheduled video conference. The URL can likewise be shared among participants to use for joining the scheduled video conference.

The server then receives, from a first client device, a request to join the scheduled video conference including the first join token and a video conference identifier. For example, the first client device may paste the URL obtained from the published webpage into a web browser to cause a locally installed video conference application to connect with the server to initiate or join the scheduled video conference.

The server identifies the scheduled video conference using the video conference identifier. For example, the video conference identifier can be used to identify the scheduled video conference among a number of such scheduled video conferences. The server then joins the first client device to the scheduled video conference using the first join token. For example, the server may coordinate among a number of controller or multimedia router instances on the regional WAN to allocate and initialize the audio and video streaming services needed for the scheduled video conference. The join token provides authentication for joining the scheduled video conference. The server can provide information about the allocated multimedia routers to the client device, which can then begin to communicate with other participant client devices that have similarly joined using the multimedia routers to send and receive the audio and video streams between and among the participants.

Systems and methods according to the present disclosure provide significant improvements in the technical field of video conferencing administration. In contrast to existing approaches, techniques described are automatic and do not require any significant changes from normal actions for participant client devices. This maximizes their usability by non-technical individuals in the event of an interruption event. The techniques are also secure, providing token-based authentication even in the absence of the identity servers provided by the video conference provider under normal circumstances, thus improving on the security of survivable meetings as compared with existing approaches. The use of locally coordinated and allocated multimedia routers can result in efficiently utilized and dynamic bandwidth allocation, conserving network resources when it is most needed in an emergent scenario.

These illustrative examples are given to introduce the reader to the general subject matter discussed herein and the disclosure is not limited to these examples. The following sections describe various additional non-limiting examples of systems and methods for scheduled video conference survivability.

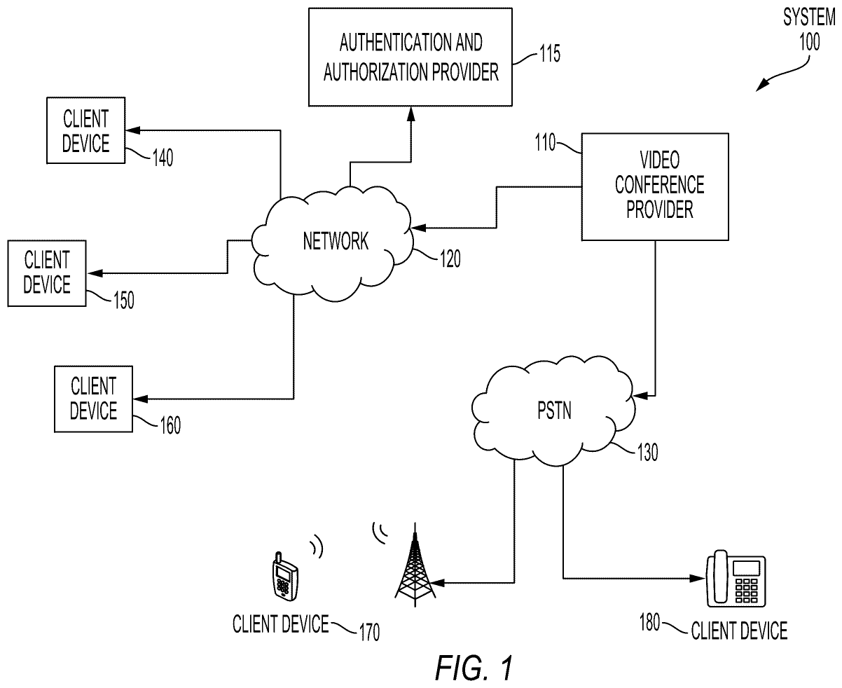

Referring now to FIG. 1, FIG. 1 shows an example system 100 that provides videoconferencing functionality to various client devices. The system 100 includes a video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a video conference provider 110 may supply components to enable a private organization to host private internal video conferences or to connect its system to the chat and video conference provider 110 over a public network.

The system optionally also includes one or more user identity providers, e.g., user identity provider 115, which can provide user identity services to users of the client devices 140-160 and may authenticate user identities of one or more users to the chat and video conference provider 110. In this example, the user identity provider 115 is operated by a different entity than the chat and video conference provider 110, though in some examples, they may be the same entity.

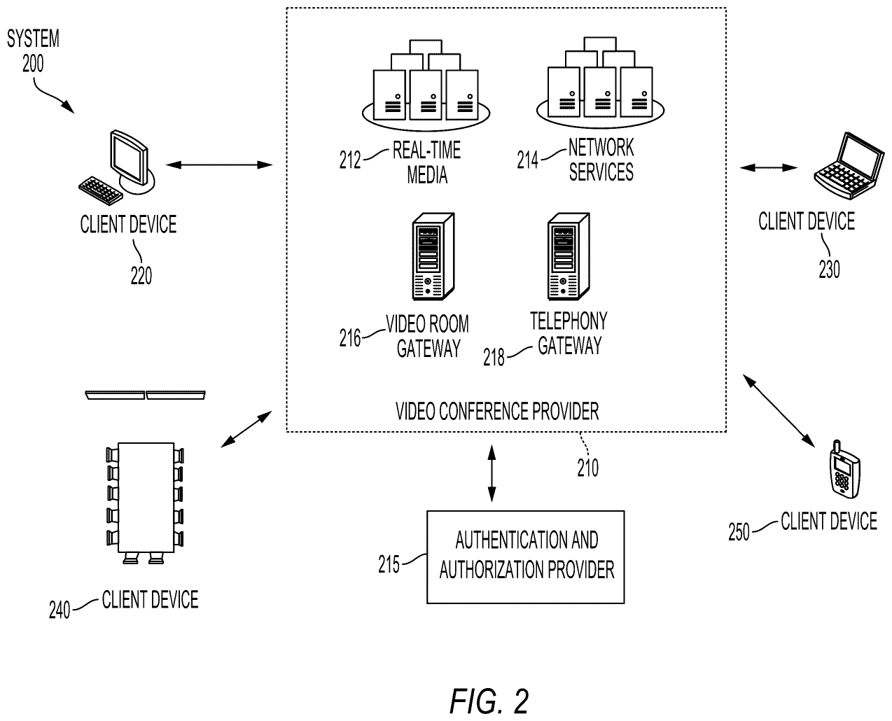

Video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user identification information, meeting identifiers, meeting passwords or passcodes, etc. In examples that employ a user identity provider 115, a client device, e.g., client devices 140-160, may operate in conjunction with a user identity provider 115 to provide user identification information or other user information to the chat and video conference provider 110.

A user identity provider 115 may be any entity trusted by the chat and video conference provider 110 that can help identify a user to the chat and video conference provider 110. For example, a trusted entity may be a server operated by a business or other organization with whom the user has established their identity, such as an employer or trusted third-party. The user may sign into the user identity provider 115, such as by providing a username and password, to access their identity at the user identity provider 115. The identity, in this sense, is information established and maintained at the user identity provider 115 that can be used to identify a particular user, irrespective of the client device they may be using. An example of an identity may be an email account established at the user identity provider 115 by the user and secured by a password or additional security features, such as two-factor authentication. However, identities may be distinct from functionality such as email. For example, a health care provider may establish identities for its patients. And while such identities may have associated email accounts, the identity is distinct from those email accounts. Thus, a user's “identity” relates to a secure, verified set of information that is tied to a particular user and should be accessible only by that user. By accessing the identity, the associated user may then verify themselves to other computing devices or services, such as the chat and video conference provider 110.

When the user accesses the chat and video conference provider 110 using a client device, the chat and video conference provider 110 communicates with the user identity provider 115 using information provided by the user to verify the user's identity. For example, the user may provide a username or cryptographic signature associated with a user identity provider 115. The user identity provider 115 then either confirms the user's identity or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide user identification information to identify the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but they may be identified only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide user identification information to the chat and video conference provider 110, even in cases where the user has an authenticated identity and employs a client device capable of identifying the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more user identity providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia streams in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system 210 and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting a user identity provider 215 to verify the provided credentials. Once the user's credentials have been accepted, the network services servers 214 may perform administrative functionality, like updating user account information, if the user has an identity with the chat and video conference provider 210, or scheduling a new meeting, by interacting with the network services servers 214.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may identify the user and issue a command through a user interface on their client device. The command may be sent to a network services server 214, which may then disconnect the identified user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices'participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

In some embodiments, in addition to the video conferencing functionality described above, the chat and video conference provider 210 (or the chat and video conference provider 110) may provide a chat functionality. Chat functionality may be implemented using a message and presence protocol and coordinated by way of a message and presence gateway 217. In such examples, the chat and video conference provider 210 may allow a user to create one or more chat channels where the user may exchange messages with other users (e.g., members) that have access to the chat channel(s). The messages may include text, image files, video files, or other files. In some examples, a chat channel may be “open,” meaning that any user may access the chat channel. In other examples, the chat channel may require that a user be granted permission to access the chat channel. The chat and video conference provider 210 may provide permission to a user and/or an owner of the chat channel may provide permission to the user. Furthermore, there may be any number of members permitted in the chat channel.

Similar to the formation of a meeting, a chat channel may be provided by a server where messages exchanged between members of the chat channel are received and then directed to respective client devices. For example, if the client devices 220-250 are part of the same chat channel, messages may be exchanged between the client devices 220-240 via the chat and video conference provider 210 in a manner similar to how a meeting is hosted by the chat and video conference provider 210.

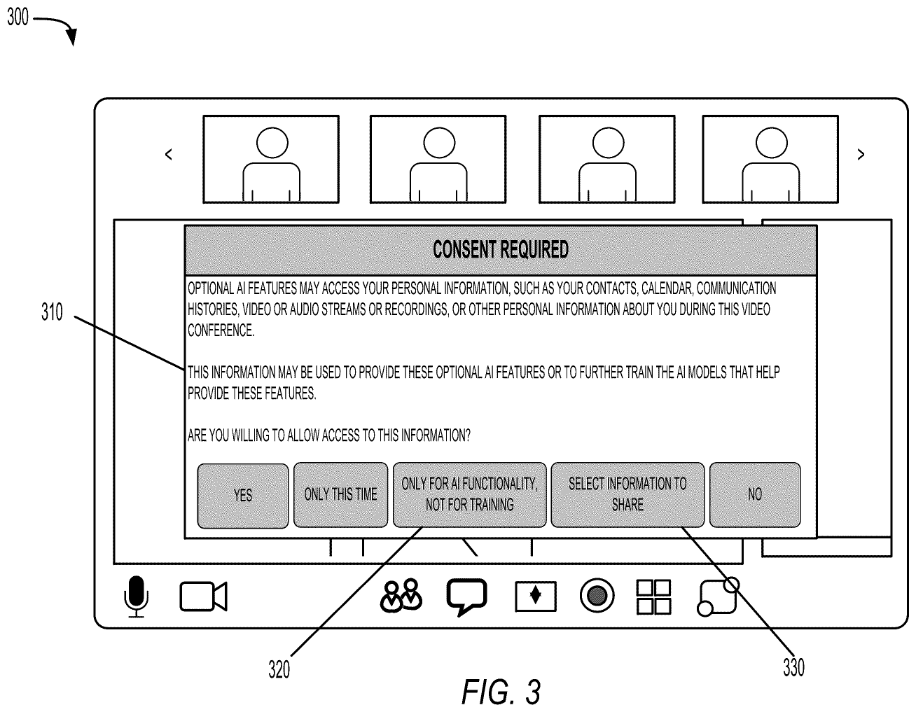

Turning next to FIG. 3, FIG. 3 shows an example user interface 300 that may be used in some example systems configured for scheduled video conference survivability, according to some aspects of the present disclosure. In some examples according to the present disclosure, a user may select an option to use one or more optional AI features available from the virtual conference provider 302. The use of these optional AI features may involve providing the user's personal information to the AI models underlying the AI features. The personal information may include the user's contacts, calendar, communication histories, video or audio streams, recordings of the video or audio streams, transcripts of audio or video conferences, or any other personal information made available to the virtual conference provider. Further, the audio or video feeds may include the user's speech, which includes the user's speaking patterns, cadence, diction, timbre, and pitch; the user's appearance and likeness, which may include facial movements, eye movements, arm or hand movements, and body movements, all of which may be employed to provide the optional AI features or to train the underlying AI models.

Before capturing and using any such information, whether to provide optional AI features or when providing training data for the underlying AI models, the user may be provided with an option to consent, or deny consent, to access and use some or all of the user's personal information. In general, Zoom's goal is to invest in AI-driven innovation that enhances user experience and productivity while prioritizing trust, safety, and privacy. Without the user's explicit, informed consent, the user's personal information will not be used with any AI functionality or as training data for any AI model. Additionally, these optional AI features are turned off by default-account owners and administrators control whether to enable these AI features for their accounts, and if enabled, individual users may determine whether to provide consent to use their personal information.

As can be seen in FIG. 3, a user has engaged in a video conference and has selected an option to use an available optional AI feature. In response, the GUI has displayed a consent authorization window 310 for the user to interact with. The consent authorization window 310 informs the user that their request may involve the optional AI feature accessing multiple different types of information, which may be personal to the user. The user can then decide whether to grant permission or not to the optional AI feature generally, or only in a limited capacity. For example, the user may select an option 320 to only allow the AI functionality to use the personal information to provide the AI functionality, but not for training of the underlying AI models. In addition, the user is presented with the option 330 to select which types of information may be shared and for what purpose, such as to provide the AI functionality or to allow use for training underlying AI models.

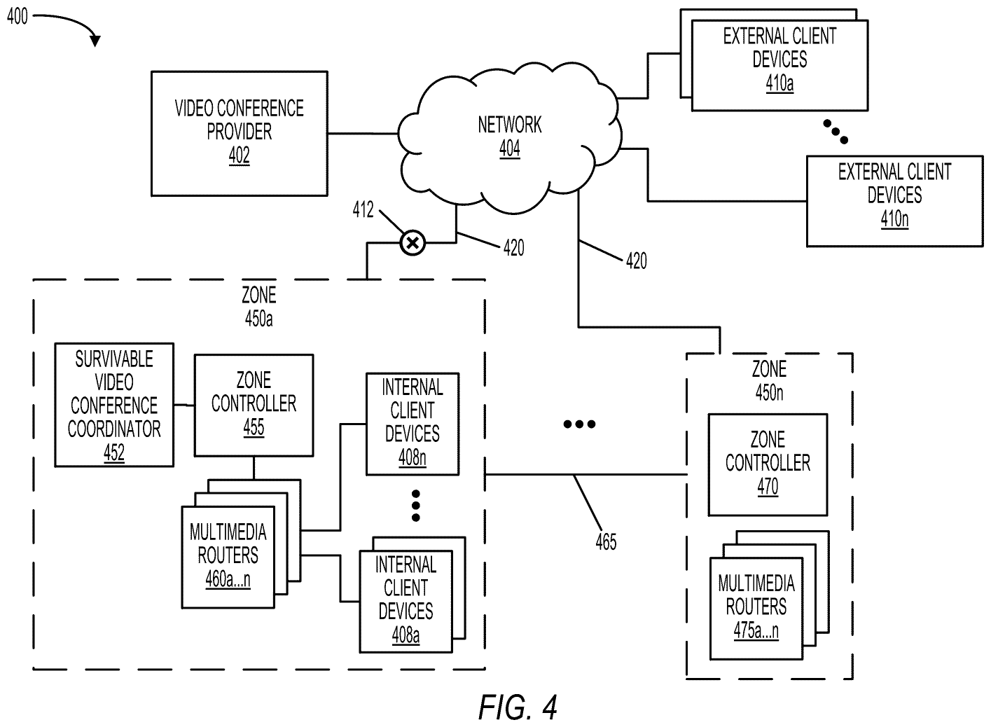

Referring now to FIG. 4, FIG. 4 shows an example of a system 400 for providing scheduled video conference survivability, according to some examples of the present disclosure. System 400 shows video conference provider 402 providing video conferencing and other digital communication services to two groups of client devices, internal client devices 408a. . .n and external client devices 410a. . .n communicatively coupled with video conference provider 402 over a network 404.

The video conference provider 402 is typically a server or collection of servers, including a combination of privately or cloud-hosted devices. Video conference provider 402 may be similar, in some respects, to the video conference providers 110, 210 described above with respect to FIGS. 1 and 2. The network 404 may include the Internet, public networks, private networks, or combinations thereof.

Client devices 408a. . .n, 410a. . .n may be any type of device capable of executing the appropriate client software for providing scheduled video conference survivability. For example, the client devices 408a. . .n, 410a. . .n may be laptops, desktops, smartphones, tablets, internet protocol (IP) phones, and so on. In at least one aspect, the video conference provider 402 may function to host the video conferences for the participants to join using the client devices 408a. . .n, 410a. . .n.

The participants may connect to a video conference from some or all of the zones 450a. . .n. Each zone 450a of the zones 450a. . .n may represent a different location such as a room in a building, a campus, a city, a country, or a geographical region. As an example, survivable meeting zone 450a may be a geographical region near a commercial complex in Wilmington, North Carolina while survivable meeting zone 450n may include all of California. The zones 450a. . .n can be designated by an organizational administrator based on the availability of survivable multimedia routers (described below) to localize the use of audio and video streaming to the nearest site location.

The components included in a zone 450a may be connected to a common private network (e.g., via LAN, WAN, or similar). While internal client devices 408a. . .n are referred to herein as “internal” or on a “private network”, it should not be considered limiting in terms of a type of network they exist on but rather that each of the internal client devices 408a. . .n is served by the survivable video conference coordinator 452. The internal client devices 408a. . .n may include personal computers, smartphones, or any device that can connect participants to a video conference using a graphical user interface (“GUI”). A participant may use the internal client devices 408a. . .n to transmit a request to the video conference provider 402 to host the video conference when the network connections 420 to the video conference provider 402 are available.

A size of each zone 450a (e.g., number of connected devices or a real-world physical zone encapsulating connected devices) may be pre-determined or may be dynamically determined (based on network quality, ping, user defined, or similar). For example, the size of each zone 450a may be determined by network connection quality between dynamically determined groups of internal client devices 408a. . .n in different regions.

Client devices connecting to a video conference hosted by the video conference provider 402 from within a zone 450a are referred to as internal client devices 408a. . .n. Internal client devices 408a. . .n are thus “internal” to a respective zone 450a. External client devices 410a. . .n are not included in any of the zones 450a. . .n. For example, the external client devices 410a. . .n may include client devices that are connected to the video conference provider 402 from remote network locations over the Internet.

The participants using the internal client devices 408a. . .n to connect to the video conference may share media content (e.g., audiovisual signals, streams, or similar) with one another over the network 404. Additionally, external client devices 410a. . .n may also share media content with the internal client devices 408a. . .n over the network 404 as well. In general, the network 404 enables participants to interact with each other within the video conference.

Each zone 450a includes a collection of components for providing scheduled video conference survivability. While configurations for one zone 450a are discussed herein for brevity, it should not be considered limiting and each of the zones 450a. . .n should be considered to have some or all of the functionality of the example zone 450a discussed in detail. For example, zone 450n is shown with only a subset of the components shown in zone 450a for clarity.

Zone 450a includes a survivable video conference coordinator 452. The survivable video conference coordinator 452 may be a dedicated physical server, virtual machine, cloud compute instance, or a combination thereof. The survivable video conference coordinator 452 can be configured to coordinate video conferences among the internal client devices 408a. . .n when during an interruption event 412 (e.g., power outage, network connection loss, or similar) that may disrupt the network connection 420.

Upon determining that a network connection to the video conference provider 402 is not available following an interruption event 412, the survivable video conference coordinator 452 may receive, from an internal client device 408a, a request to join a scheduled video conference. Information about the scheduled video conference may be received from and periodically updated by the video conference provider 402.

To join the internal client device to the scheduled video conference, the survivable video conference coordinator 452 can first identify a zone controller 455. The zone controller 455 can be a survivable server zone controller that enables the internal client devices 408a. . .n to locate survivable multimedia routers 460a. . .n in the zone 450a or multimedia routers reachable from the zone 450a, such as multimedia routers 475a. . .n in another zone 450n over network connection 465. The latter case may be used for large deployments configured to share multimedia router resources or to use multiple survivable multimedia routers to scale video conferencing services during an interruption event 412.

The survivable video conference coordinator 452 can direct the zone controller 455 to provision one or more multimedia routers 460a. . .n for the scheduled video conference and to initiate the scheduled video conference using the one or more provisioned multimedia routers 460a. . .n. For example, the survivable video conference coordinator 452 can send information about the number of internal client devices 408a. . .n expected for the scheduled video conference, the start time and duration of the scheduled video conference, the location of the internal client devices 408a. . .n, and so on.

The zone controller 455 can then locate multimedia routers 460a. . .n in the zone 450a or multimedia routers reachable from the zone 450a, such as multimedia routers 475a. . .n in another zone 450n over network connection 465 to support the scheduled video conference. For example, certain zones 450a (e.g., large WANs deployed by an organization) can be configured to share multimedia router resources or to use multiple multimedia routers as needed an interruption event 412 to provide flexible scaling capability. Zone 450n has a zone controller 470 that can be communicated with by zone controller 455 to coordinate the provisioning of shared multimedia routers 460a. . .n, 475a. . .n between the zones 450a, 450n.

The multimedia routers 460a. . .n may be specialized router resources such as dedicated routers or servers configured to handle multiplexing and routing of video and audio streams during a video conference. The multimedia routers 460a. . .n can manage the real-time encoding, packetization, and distribution of multiple media streams, as well as optimizing bandwidth usage and minimizing latency across the zone 450a.

The survivable video conference coordinator 452 can then output commands to cause the participant internal client devices 408a. . .n to join the scheduled video conference by communicating with the provisioned multimedia routers 460a. . .n. For example, the survivable video conference coordinator 452 can provide IP addresses or network locations of the provisioned multimedia routers 460a. . .n to the participant internal client devices 408a. . .n. The survivable video conference coordinator 452 can also provide authentication information to the multimedia routers 460a. . .n corresponding to the expected participant internal client devices 408a. . .n.

The multimedia routers 460a. . .n (as well as shared multimedia routers 475a. . .n) can be configured to “mix” audio, video and application sharing content. In this context, “mix” can refer generally to multiplexing of audio streams, video streams, shared application content, or other data between and among the participant internal client devices 408a. . .n. Following the provisioning of the multimedia routers 460a. . .n, responsibility for operation and coordination of the scheduled video conference is passed to the multimedia routers 460a. . .n from the zone controller 455.

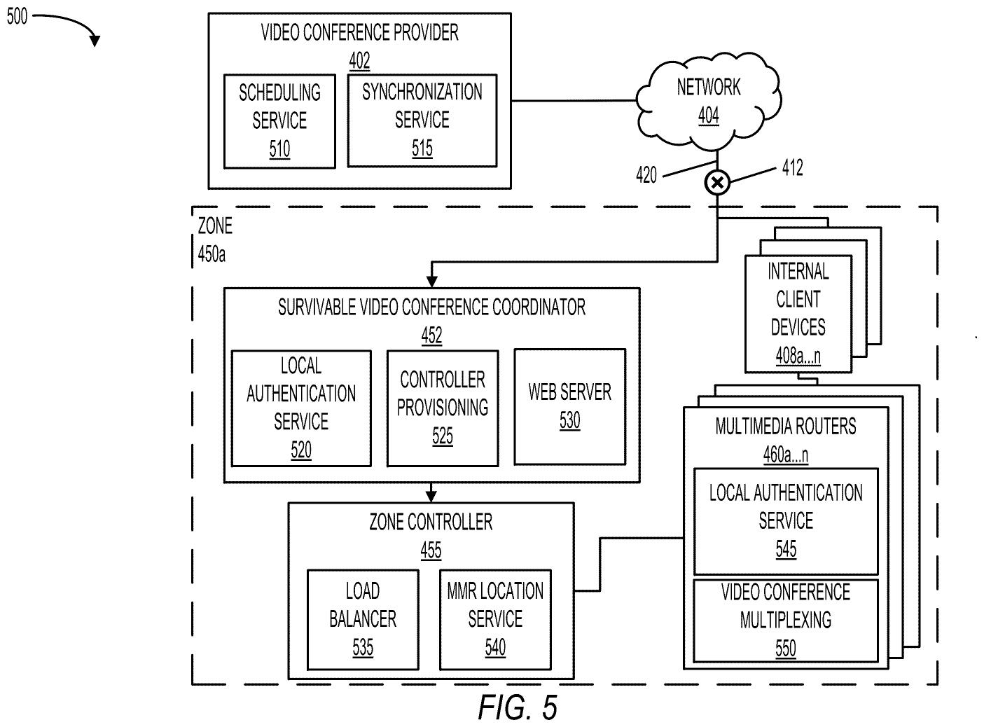

Referring now to FIG. 5, FIG. 5 shows another example of a system 500 for providing scheduled video conference survivability, according to some examples of the present disclosure. In particular, system 500 includes a detailed view of some components described above in FIG. 4. While references will be made to specific components of the examples system shown in FIG. 4, it should be appreciated that the example system 500 shown in FIG. 5 is compatible with any example described herein.

Upon initialization, the survivable video conference coordinator 452 initially communicates with the video conference provider 402. For instance, the survivable video conference coordinator 452 can provide information to the video conference provider 402 to register the survivable video conference coordinator 452 with the video conference provider 402. Such information may include a LAN network address (e.g., an IP address, a server name, or similar) or information about the survivable video conference coordinator 452 (e.g., number of participants connected to the zone 450a, location, device name, or similar). The survivable video conference coordinator 452 may also provide configuration information for one or more software components installed on the survivable video conference coordinator 452 to the video conference provider 402. Such configuration information may enable the video conference provider 402 to determine whether any configuration updates are needed and to provide such updates prior to, during, or after the video conference.

More specifically, the video conference provider 402 can provide configuration information for providing scheduled video conference survivability for the internal client devices 408a. . .n within zone 450a. For example, the video conference provider 402 can provide configuration information for the zone controller 455 consumption model, including designating of the multimedia routers 460a. . .n for loss of connectivity scenarios or for sharing the multimedia routers 460a. . .n across zones 450a. . .n for routine video conferencing and other digital communications, as shown in FIG. 4.

Enablement of survivable scheduled video conferences begin with scheduling an upcoming video conference at the video conference provider 402. The video conference provider 402 includes a scheduling service 510 that can be accessed using a suitable application programming interface (“API”) (e.g., a web-based Representational State Transfer (“REST”) API). The API provided by the scheduling service 510 can be accessed directly using third-party tools or using a GUI provided by the video conference provider 402 in a video conference client application from a client device.

In general, scheduling the survivable video conference can proceed normally as per scheduling of a non-survivable video conference. For example, scheduling the survivable video conference can involve designating a time, date, participants, meeting agenda, and so on. In this case, the scheduler can also select a configuration option to designate the meeting type as being survivable. For instance, a video conference can be manually designated as survivable using, for instance, a check box in a configuration screen. In some cases, video conferences can be implicitly or automatically designated as survivable according to policy assigned to the user. For instance, an organizational administrator may configure a policy for member users that requires certain types of video conferences to be survivable. The scheduling service 510 can automatically designate such video conferences as survivable. Once the video conference is scheduled, the information about the scheduled video conference can be pushed to the survivable video conference coordinator 452.

The survivable video conference coordinator 452 can receive, from the video conference provider 402, the information about upcoming scheduled video conferences. The information may include, for example, join tokens for authentication and alphanumeric video conference identifiers, as well as information about meeting subject, date, time, participants, and so on. The information about the upcoming scheduled video conferences can be stored in a suitable persistent or ephemeral memory such as a filesystem, database, in-memory cache, and so on included with or accessible by survivable video conference coordinator 452.

The video conference provider 402 also includes a synchronization service 515 that periodically sends updates about scheduled video conferences to the survivable video conference coordinator 452. For example, if the originator of the scheduled video conference makes changes (e.g., changes the time or adds participants), these changes can be pushed periodically to the survivable video conference coordinator 452. The survivable video conference coordinator 452 can thus maintain a local mirror of upcoming, scheduled survivable video conferences that is at most a predetermined periodicity out of date. The periodicity may be selected to maximize the currency of the locally stored scheduled video conference information but to not needlessly consume network bandwidth. Typical periodicities may be on the order of several minutes or several hours.

The internal client devices 408a. . .n can use network transport state to determine if a network connection to the video conference provider 402 is still active. When the network connection to the video conference provider 402 is not available due to an interruption event 412 such as a loss of network connectivity to the video conference provider 402, a natural disaster, a civil disturbance, etc., coordination and operation of scheduled video conferences can shift automatically to components accessible over the network constituting zone 450a. In some examples, the shift to coordinating and operating scheduled video conferences using local components can be caused by a manual toggle set by, for example, an organizational administrator.

The survivable video conference coordinator 452 includes a local authentication service 520. The local authentication service 520 can provide authentication for the internal client devices 408a. . .n that would normally be provided by the video conference provider 402 using, for example, an identity provider. For example, the local authentication service 520 can use network-based authentication to verify that authenticating client devices are on the LAN or WAN constituting zone 450a as well as other means of authentication such as allow-listing of MAC addresses or mirrored password hashes. In some examples, the local authentication service 520 can maintain a local mirror of certain authentication credentials (e.g., password hashes) to provide password-based authentication. The internal client devices 408a. . .n can authenticate to the survivable video conference coordinator 452 via the local authentication service 520 to obtain information for connecting to survivable video conferences such as server lists and join tokens.

The survivable video conference coordinator 452 includes a web server 530 that can be used to publish information about scheduled video conferences to the internal client devices 408a. . .n. For example, the web server 530 can publish a bulletin board with general information about the zone 450a such as operational information (e.g., IT support instructions), security alarms, site emergency information, radio and telephone contacts, and so on.

The web server 530 can also publish information about upcoming scheduled video conferences. For example, the web server 530 can generate a dynamic web page including dates, times, descriptions, invitees, host information and so on. The dynamic web page can include a survivable meeting URL link (also referred to as a “SMURL” or “survivable meeting URL”) which is provided to all meeting attendees. In addition to the example of a web page given here, the information about upcoming scheduled video conferences can likewise be published to other devices such as mobile devices, dedicated video conference hardware, and so on. Additionally, the information can be sent using other media such as mobile notifications, email, text messages, desktop alerts, and so on. The web server 530 can perform configuration and security provisioning for the internal clients 408a. . .n. For example, the web page can include an alphanumeric video conference identifier for each scheduled video conference as well as an alphanumeric join token that can be used by the internal client devices 408a. . .n to authenticate to the scheduled video conference without contacting the video conference provider 402.

The web server 530 can also coordinate various functions needed to provide scheduled video conference survivability. For example, web server 530 (or a web application executing thereon) can be used to determine network connectivity status. For example, the status of the network connection 420 can be determined based on the survivability state of the internal client devices 408a. . .n and access to network resources. In this respect, the survivability state can refer generally to whether the internal client devices 408a. . .n are configured for scheduled video conference survivability or whether an indication of connectivity with the video conference provider 402 has been received from the internal client devices 408a. . .n.

The join token may be a precomputed alphanumeric string that includes cryptographically secure information about the particular client device and identifying information about the corresponding scheduled video conference. For instance, a string can be generated including an identifier of a participant or client device, the alphanumerical identifier of the video conference, and security token. The string can be cryptographically signed using a private key that is only available to the web server 530 and other components later involved with authentication for particular video conferences such as the multimedia routers 460a. . .n. In some examples, the join token may be shareable. In that case, the join token may not include information specific to a particular client device and can be shared among meeting invitees. Security for the meeting is provided by protecting the join token and limiting the sharing thereof.

The survivable video conference coordinator 452 includes a controller provisioning component 525. Upon receiving an indication of an interruption event 412, the web server 530 can output a command to the controller provisioning component 525 to identify an available zone controller 455. In some examples, the zone 450a may have one zone controller 455 but large or geographically dispersed zones may include a number of zone controllers. The controller provisioning component 525 can identify a zone controller 455 for a particular upcoming scheduled video conference that is reachable by all of the internal client devices 408a. . .n designated as participants or invitees. The controller provisioning component 525 can provide routing information (e.g., IP addresses) to a local survivable zone controller 455 to the internal client devices 408a. . .n by providing the routing information to the web server 530 which can then publish the routing information as described above.

The zone 450a includes at least one zone controller 455. The zone controller 455 may be a standalone “on-premise” physical server or virtual machine that provides load balancing and location services for a number of survivable multimedia routers 460a. . .n. The zone controller 455 includes load balancer 535 that can distribute network traffic efficiently across the among and between the available multimedia routers 460a. . .n to ensure optimal performance and reliability in accordance with the information about upcoming scheduled video conferences.

Upon receiving a request to join a scheduled video conference, the zone controller can be instructed to provision one or more multimedia routers multimedia routers 460a. . .n for the scheduled video conference and to initiate the first scheduled video conference using the one or more provisioned multimedia routers 460a. . .n. Establishing communications with and provisioning of the multimedia routers 460a. . .n can be coordinated by the multimedia router location service 540. The multimedia router location service 540 may include components for tracking the network locations of the available multimedia routers 460a. . .n and their current allocations.

The multimedia routers 460a. . .n include video conference multiplexing 550 that can provide mixing of real-time voice and video streaming between participating internal client devices 408a. . .n as well as application sharing for the connected internal client devices 408a. . .n during the interruption event 412. Additionally, the multimedia routers 460a. . .n can provide authentication services for each scheduled video conference using local authentication service 545. For example, the multimedia routers 460a. . .n, can receive a request to connect to a scheduled video conference from a client device along with a join token and alphanumerical identifier of the video conference. The local authentication service 545 can validate the join token and meeting identifier and allows the client device to join the video conference upon proper validation.

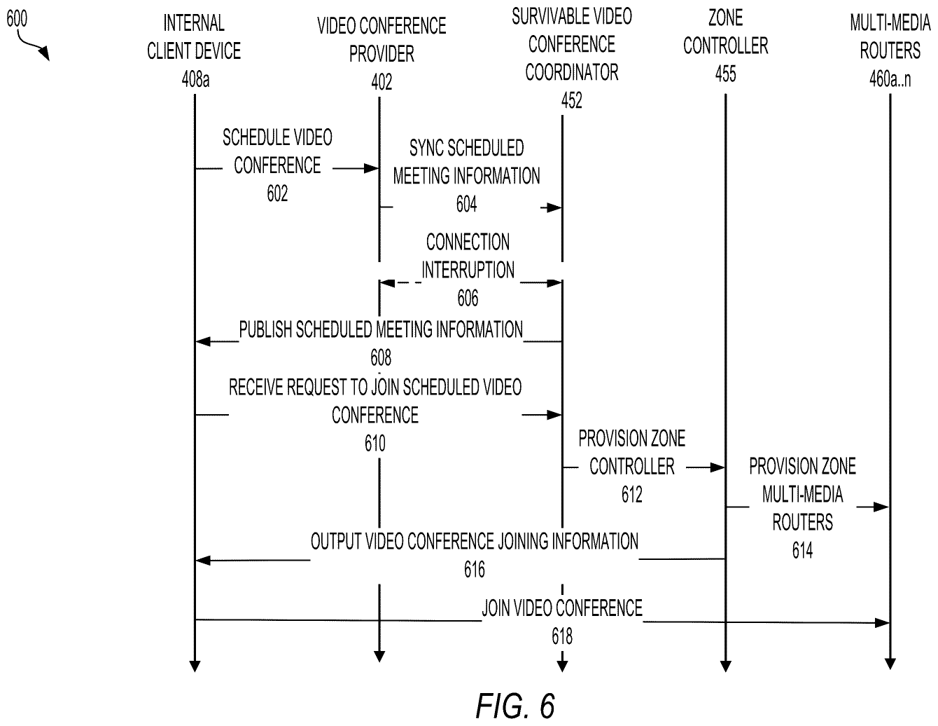

Referring now to FIG. 6, FIG. 6 shows an example sequence diagram 600 illustrating a provisioning of scheduled video conference survivability, according to some examples of the present disclosure. It should be appreciated that the sequence diagram 600 shows a particular example sequence of events for providing scheduled video conference survivability. Other sequences of operations may also be performed according to alternative examples. For example, alternative examples of the present disclosure may perform the operations outlined below in a different order. Moreover, the individual operations illustrated by sequence diagram 600 may include multiple sub-operations that may be performed in various sequences as appropriate to the individual operation. Furthermore, additional operations may be added or removed depending on the particular applications. The sequence diagram 600 shows interactions among several computing systems described above in FIGS. 4 and 5, but the operations described in sequence diagram 600 may be performed by different devices. For example, some operations may be combined in one system or executed on different computing systems. One of ordinary skill in the art would recognize many variations, modifications, and alternatives.

At 602, an internal client device 408a schedules a video conference using an API or GUI provided by the video conference provider 402. For example, video conference client software executing on the internal client device 408a can be used to schedule an upcoming video conference including specification of the date, time, invitees, security level, and survivability status. In this example, the meeting is designated as survivable, which means the video conference can proceed using the resources available in zone 450a even if the video conference provider is not reachable.

In some examples, the video conference can be a recurring video conference. For example, organizations may schedule regular, recurring meetings (sometimes referred to as “war rooms”) to ensure that a survivable meeting is always available in the event of an interruption event 412. This is important for organizations that must maintain communications following an unforeseen interruption 412 for which no meeting may have been scheduled in advance.

At 604, the video conference provider 402 synchronizes the scheduled meeting information with the survivable video conference coordinator 452. For example, the video conference provider 402 may periodically send information about all upcoming scheduled meetings to the survivable video conference coordinator 452 (e.g., every 10 minutes). Periodically sending the information about all upcoming scheduled meetings can ensure that the likelihood of current (e.g., updated), survivable video conferences are available when an interruption event 412 occurs.

At 606, the interruption event 414 occurs. The interruption event 414 is depicted using a dashed line between video conference provider 402 and survivable video conference coordinator 452 to represent the loss of network connectivity to the video conference provider, a natural disaster, a civil disturbance, and so on. The survivable video conference coordinator 452 can determine that interruption event 412 has occurred by periodically testing the network transport state using periodic “ping” requests or heartbeat signals to the video conference provider 402 or associated status server and checking for timely responses. If a connection failure or a timeout error is detected, the system concludes that event 412 has occurred and initiates the corresponding response procedures.

At 608, the survivable video conference coordinator 452 publishes the scheduled video conference information. For example, the survivable video conference 452 may include a web server that is accessible to the internal client device 408a and other participating internal client devices in the zone 450. The web server can be used to provide a web page that includes the information about the scheduled meeting, including the date, time, URL, authentication credentials, and so on. The published web page can be updated periodically as the upcoming scheduled video conference information is synchronized.

At 610, upon the occurrence of the date and time for the scheduled video conference, the survivable video conference coordinator 452 receives a request from internal client device 408a to join the scheduled video conference. For example, the video conference client software can be used to output an indication to join the video conference. The user experience, from the perspective of the internal client device, may be the same or similar to the user experience for joining a video conference operated by the video conference provider 402 to maximize survivability and reduce friction that may prevent the scheduled video conference from occurring.

At 612, the survivable video conference coordinator 452 provisions a zone controller 455. For example, some large or geographically dispersed zones may have a number of zone controllers available to service the zone 450. The survivable video conference coordinator 452 can identify a zone controller 455 and associate it with the internal client device 408. For example, the zone controller 455 can be provisioned by sending information about the internal client device 408a to the identified zone controller 455 and updating local data stores with information about the association. For zones or regions with more than one zone controller 455, provisioning of zone controller resources can prevent uneven consumption of available resources during an interruption event 412.

At 614, zone controller 455 provisions one or more multimedia routers 460a. . .n for the scheduled video conference. For example, the zone 450a may have a number of multimedia routers 460a. . .n available. The zone controller 455 can provide load balancing services for the zone 450a through provisioning of multimedia routers 460a. . .n according to the details of the scheduled video conference such as number of participants, bandwidth requirements, length, geographic dispersion of the participants, and so on.

At 616, the zone controller 455 (or the survivable video conference coordinator 452) outputs video conference joining information to the internal client device 408. In particular, the zone controller 455 (or the survivable video conference coordinator 452) can provide information for communicating with at least one of the provisioned multimedia routers 460.

At 618, the internal client device 408a outputs a request to join the video conference to the multimedia routers 460a. . .n. The provisioned multimedia routers 460a. . .n can authenticate the meeting join request using provided credentials such as the meeting ID, join token, etc. and begin mixing real time media for the internal client device 408. For example, the multimedia routers 460a. . .n can process and integrate multiple audio and video streams among and between the participating internal client devices. In some examples, the zone controller 455 can provide load balancing and location services for the multimedia routers 460a. . .n during the in-progress video conference.

As described above, the multimedia routers 460a. . .n can be configured to “mix” audio, video and application sharing content. Following the provisioning of the multimedia routers 460a. . .n (e.g., based on load balancing), responsibility for operation and coordination of the scheduled video conference is passed to the multimedia routers 460a. . .n from the zone controller 455. In some examples, the multimedia routers 460a. . .n can operate and coordinate the video conference independently of other components. In some examples, cluster links or “cascades” may be established among other multimedia routers 475a. . .n multimedia routers in other zones (e.g., zone 450n from FIG. 4) to enable the video conference to scale across multiple data centers, geographic locations, regions, zones, and so on.

Various scheduled video conferences may use one, two, or more multimedia routers 460a. . .n depending on the expected or actual load, number of participants, network congestion, and so on. For examples with more than one multimedia router, the first multimedia router to which a participant client device is joined may be referred to as the “top” multimedia router. Additional multimedia routers 460a. . .n that may be added internally to the zone 450n or cascaded externally from another zone 450n may be referred to a “sub” multimedia routers, which can be short for “subscriber.” The use of subscriber multimedia routers 460a. . .n, 475a. . .n can enable elastic scaling for survivable video conferences with up to thousands or even millions of participants.

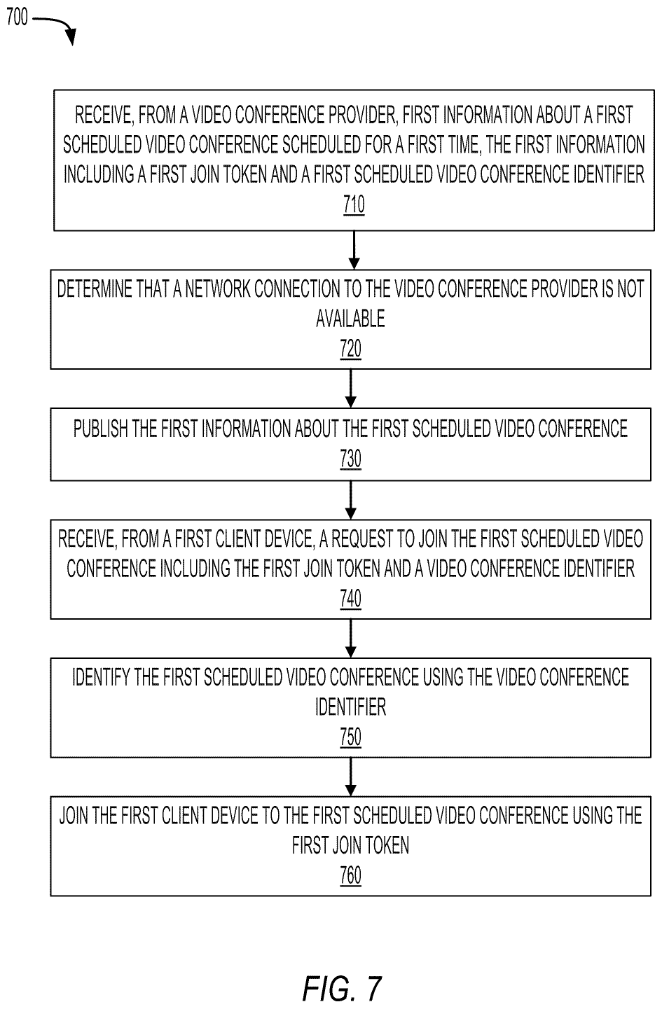

Referring now to FIG. 7, FIG. 7 shows a flowchart of an example method 700 for providing scheduled video conference survivability, according to some examples of the present disclosure. The description of the method 700 in FIG. 7 will be made with reference to FIGS. 4-6, however any suitable system according to this disclosure may be used, such as the example systems 100 and 200, shown in FIGS. 1 and 2. It should be appreciated that method 700 provides a particular method for providing scheduled video conference survivability. Other sequences of operations may also be performed according to alternative examples. For example, alternative examples of the present disclosure may perform the steps outlined below in a different order. Moreover, the individual operations illustrated by method 700 may include multiple sub-operations that may be performed in various sequences as appropriate to the individual operation. Furthermore, additional operations may be added or removed depending on the particular applications. Further, the operations described in method 700 may be performed by different devices. For example, the description is given from the perspective of the survivable video conference coordinator 452 but other configurations are possible. One of ordinary skill in the art would recognize many variations, modifications, and alternatives.

The first client device may be collocated with one or more zone controllers and one or more multimedia routers on a network, sometimes referred to as a zone 450a or region, along with the survivable video conference coordinator 452. The survivable video conference coordinator 452 and other components in the zone coordinate to provide scheduled video conference survivability.

The method 700 may include block 710. At block 710, a computing system such as the survivable video conference coordinator 452, receives, from a video conference provider 402, first information about a first scheduled video conference scheduled for a first time. In some examples, the first information about the first scheduled video conference may be received periodically while the network connection is available. For example, the video conference provider 402 may be configured to send the information more or less frequently depending on the criticality of the video conference survivability and at the expense of network bandwidth. For instance, the video conference provider 402 may be configured to output the first information every 10 milliseconds, every 10 seconds, or every 10 minutes.

The first information includes a first join token and a first scheduled video conference identifier (e.g., an integer or base 64 encoded string). The first join token may be, for example, an alphanumeric string that encodes information about the first client device and a cryptographic signature. For example, information about the first client device such as the first scheduled video conference identifier, the MAC address, user identifier, authentication credentials, expiration time, and so on can be concatenated and base 64 encoded. The resulting base 64 encoded string can be digitally signed using a private key shared between the survivable video conference coordinator 452 and the multimedia routers 460a. . .n that will be used to authenticate the first client device.

At block 720, the computing system determines that a network connection to the video conference provider is not available. For example, the network connection may become unavailable due to a loss of network connectivity to the video conference provider, a natural disaster, a civil disturbance, or other cause. In some examples, the determination can be made by outputting one or more transport layer packets to the video conference provider 402 and determining whether one or more transport layer response packets are received in response within a predefined period of time. For instance, TCP SYN packet can be used to establish a TCP connection with the video conference provider 402 to test transport layer response. If SYN-ACK packets are not received within a predetermined period of time (e.g., 30 seconds or other timeout value) the network connection with the video conference provider 402 may be determined to be unavailable. In some examples, the network connection can be determined to be unavailable by receiving an indication, from another, second client device, that the network connection to the video conference provider 402 is not available. For example, if the second client device reports a series of failed attempts to ping the video conference provider 402, the survivable video conference coordinator 452 can infer that the network connection is unavailable.

At block 730, the computing system publishes the first information about the first scheduled video conference. For example, the survivable video conference coordinator 452 can use a web server to deploy a web page that includes information about all upcoming video conferences including the date, time, URL, authentication credentials, and so on. The deployed web page can be dynamically generated using a suitable web framework and updated periodically as the upcoming scheduled video conference information is received from the video conference provider 402. The web page may provided behind a local authentication service 520. For example, the web page may only be served to requesting client devices that are verified to be on the same subnetwork as the web page itself or other designated network locations.

At block 740, the computing system receives, from a first client device, a request to join the first scheduled video conference including the first join token and a video conference identifier. For example, the web page deployed in block 730 may show a URL that can be used to join the scheduled video conference using a seamless, single click by including the video conference alphanumerical identifier and authentication (e.g., cryptographically signed join token) information in an encoded URL.

At block 750, the computing system identifies the first scheduled video conference using the video conference identifier. For example, the survivable video conference coordinator 452 may maintain a local data store of upcoming scheduled video conferences and associated metadata. The local data store may also include information about zone controller and multimedia router allocation and provisioning. For example, upon receiving the request to join the scheduled video conference from the first client device based on the information retrieved from the published web page, the survivable video conference coordinator 452 can identify a zone controller to handle the scheduled video conference. The survivable video conference coordinator 452 can output a command to cause the zone controller to provision one or more multimedia routers for the first scheduled video conference and to initiate the first scheduled video conference using the one or more provisioned multimedia routers. An index of the provisioned zone controller(s) and multimedia routers for a given scheduled video conference can be maintained by the survivable video conference coordinator 452.

At block 760, the computing system joins the first client device to the first scheduled video conference using the first join token. For example, the survivable video conference coordinator 452 can output the received first join token to the one or more provisioned multimedia routers then output a command to cause the first client device to join the first scheduled video conference by communicating with at least one of the one or more provisioned multimedia routers. For instance, the survivable video conference coordinator 452 can provide the IP addresses or hostnames of the provisioned multimedia routers 460a. . .n to the first client device. The first client device can be configured to, automatically or upon receiving a confirmation from the user, join the first scheduled video conference.

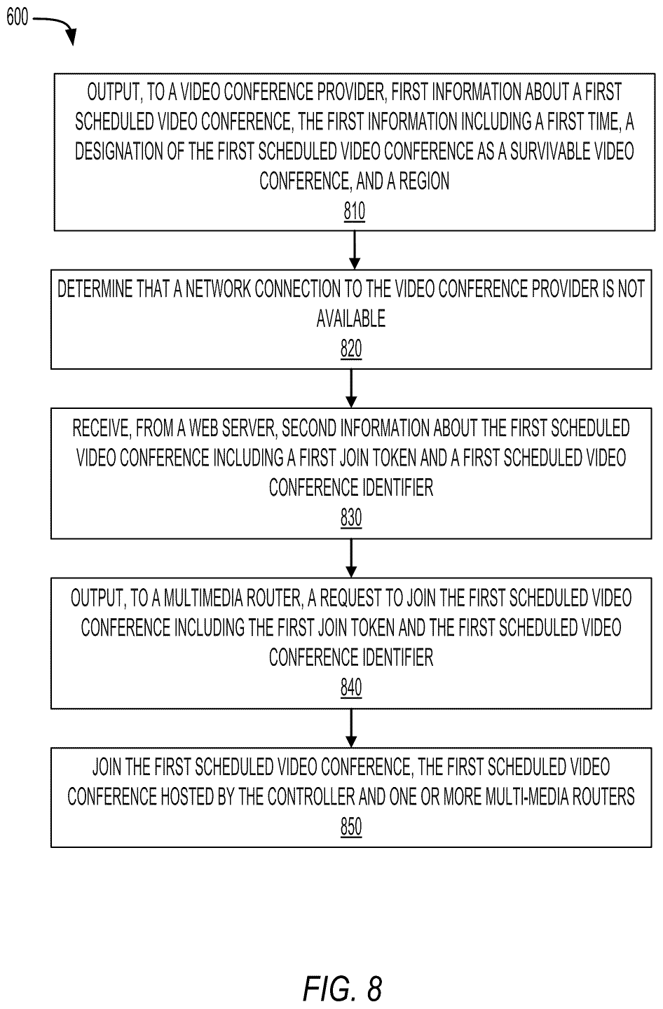

Referring now to FIG. 8, FIG. 8 shows a flowchart of an example method 800 for providing scheduled video conference survivability, according to some examples of the present disclosure. The description of the method 800 in FIG. 8 will be made with reference to FIGS. 4-6, however any suitable system according to this disclosure may be used, such as the example systems 100 and 200, shown in FIGS. 1 and 2. It should be appreciated that method 800 provides a particular method for providing scheduled video conference survivability. Other sequences of operations may also be performed according to alternative examples. For example, alternative examples of the present disclosure may perform the steps outlined above in a different order. Moreover, the individual operations illustrated by method 800 may include multiple sub-operations that may be performed in various sequences as appropriate to the individual operation. Furthermore, additional operations may be added or removed depending on the particular applications. Further, the operations described in method 800 may be performed by different devices. For example, the description is given from the perspective of a client device but other configurations are possible. One of ordinary skill in the art would recognize many variations, modifications, and alternatives.

The method 800 may include block 810. At block 810, a computing system such a client device of the internal client devices 408a. . .n outputs, to a video conference provider 402, first information about a first scheduled video conference, the first information including a first time, a designation of the first scheduled video conference as a survivable video conference, and a region. For example, video conference client software provided by the video conference provider 402 executing on the client device may provide a GUI for scheduling upcoming meetings. In some examples, email client plugins, direct API access, or a third-party groupware client can be similarly used to schedule the video conference.

The GUI may provide a control, such as a checkbox, for designating the upcoming video conference as a survivable one. As a result, the information about the first scheduled video conference can be sent to a remote computing system such as the survivable video conference coordinator 452 to make the first scheduled video conference available for internal client devices 408a. . .n in the zone 450, including the client device.

The GUI may provide a control, such as a radio selector, for designating the upcoming video conference as a public or private video conference. first. A public scheduled video conference is one that can appear in the published information, as described below in block 830. In contrast, a private scheduled video conference is one that can only be joined using a known or shared alphanumerical meeting identifier or using access provided using, for example, an existing email or calendar invitation. For instance, creating a private scheduled video conference may be followed by generation of a private URL or message that can be shared with other invitees, rather than publishing the information to all internal client devices 408a. . .n in the zone 450.

The GUI may provide a control, such as a number of checkboxes or selection menu, for selecting the survivable region that will be associated with the scheduled video conference. The survivable region can be pre-populated with an estimated value based on information about the client device 408a or a user thereof or a guess based on the IP address of the client device 408a. For example, the network the client device 408a is connected to can be used to determine the desired zone 450. Alternatively, the location of the user as designated in account settings can be used to determine the zone 450. The selected region or zone 450a will be used for synchronization of the scheduled video conference information to make the video conference survivable and available in the event of an interruption event 412.

At block 820, the computing system determines that a network connection to the video conference provider 402 is not available. Similarly to the description of block 720 above, the determination can be made by outputting one or more transport layer packets to the video conference provider 402 and determining whether one or more transport layer response packets are received in response within a predefined period of time. The determination that a network connection to the video conference provider 402 is not available can be made by the client device, the survivable video conference coordinator 452, a dedicated status server, or some combination thereof. For example, the client device can make a determination that the network connection to the video conference provider 402 is not available and accordingly provide an indication thereof to the survivable video conference coordinator 452.

At block 830, the computing system receives, from a web server, second information about the first scheduled video conference including a first join token and a first scheduled video conference identifier. For example, a server component in the zone 450a such as the survivable video conference coordinator 452 can publish the first information about the first scheduled video conference using a web server. The web server can be configured to make the first information accessible as a web page to the client device and other internal client devices 408a. . .n in the zone 450a or similar network grouping. The client device can be used to navigate to the web page using, e.g., a web browser, to obtain the first information. The first information can implicitly include a command to request to join the first scheduled video conference. For example, the first information may be a URL which, when selected, causes a request to join the first scheduled video conference to be sent to another computing system.

Accordingly, at block 840, the computing system outputs, to a multimedia router, a request to join the first scheduled video conference including the first join token and the first scheduled video conference identifier. For example, upon receiving the request to join the scheduled video conference from the client device based on the information retrieved from the published web page, the survivable video conference coordinator 452 can provision a zone controller 455 as described above in block 750. The zone controller 455 can then provision one or more multimedia routers for the first scheduled video conference and to initiate the first scheduled video conference using the one or more provisioned multimedia routers. An index of the provisioned zone controller(s) and multimedia routers for a given scheduled video conference can be maintained by the survivable video conference coordinator 452. Information about the provisioned multimedia routers can be output to the client device following receipt of the request to join, for example, during a handshake or initialization process. In response, the client device can output the first join token and the first scheduled video conference identifier to the provisioned multimedia router or routers.

In addition to joining using information from a public listed meeting in the published web page or “bulletin view,” the request to join can be output or initiated using other methods. For example, a scheduled video conference can be joined using a URL pasted into a web browser or manually joined by typing in an alphanumerical meeting identifier and meeting passcode. In cases where a URL is generated for joining the scheduled video conference, the URL can be shared among any users with suitable WAN access. The security of the scheduled video conference is then based on the security of the shared URL, which can include authentication information.

At block 850, the computing system joins the first scheduled video conference, the first scheduled video conference hosted by the controller and one or more multimedia routers. For example, following receipt of the first join token and the first scheduled video conference identifier, the multimedia router can validate the first join token using a private key shared with the survivable video conference coordinator 452 using to cryptographically sign the information contained therein. The multimedia router can then begin to send multiplexed audio and video streams to the client device and other participants among the internal client devices 408a. . .n to facilitate the video conference.

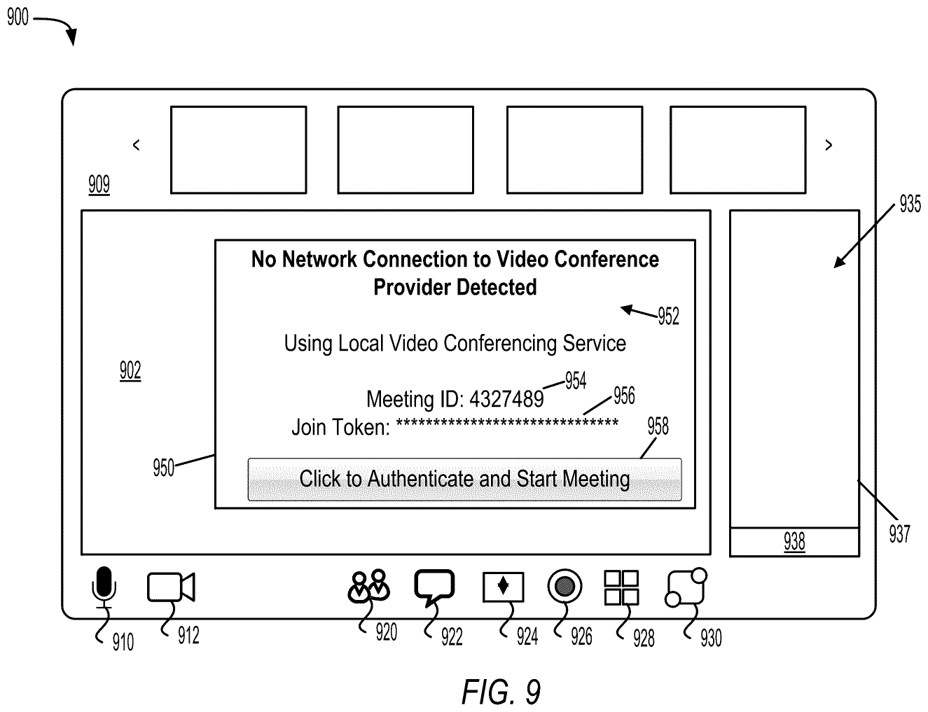

Turning next to FIG. 9, FIG. 9 shows an example of a UI 900 as may be used in some example systems for scheduled video conference survivability, according to some aspects of the present disclosure. FIG. 9 depicts an example of a UI 900 that may be shown on a display device of an internal client device 408a during video conferencing or chat messaging, although the techniques of this disclosure may be implemented in a variety of client UI contexts. In particular, UI 900 depicts a UI 900 that may be shown on the display device of an example internal client device 408a upon attempting to join a scheduled video conference following an interruption event 412 as described above with respect to FIGS. 4 and 5.

UI 900 shows an in-progress video conference as may be provided by suitable video conference client software. UI 900 includes a main speaker window 902. In some examples, the UI 900 is configured to display a participant that is currently speaking (e.g., “speaker view”) on the main speaker window 902, but other configurations are possible. For instance, some examples include a UI control for “pinning” a particular participant who can be shown in main speaker window 902 regardless of who is speaking. In this example, because the video conference has not yet started, no participant is shown.

The UI 900 can include a number of video conference participants 909. In the UI 900 configuration depicted, the participants 909, when present, are shown at the top of the UI 900. Depending on the configuration, in various examples, the participants 909 may be arrayed in a grid-like fashion, may not be shown at all, or may be displayed in some other manner. In this example, the participants 909 are shown above the main speaker window 902 as smaller participant windows, which allow the participant to view some of the other participants in the video conference, as well as controls (“<” and “>”) to let the host scroll to view other participants in the video conference.

The UI 900 includes a number of controls for configuring the video conference or interacting with the participants 909. For example, the UI 900 includes controls 910 and 912 allow a participant to toggle on or off audio or video streams captured by a microphone or camera connected to the internal client device 408a. Control 920 allows the participant to view any other participants present in the video conference along with the participant. Control 922 allows the participant to execute an application or client software function to send text or chat messages to other participants, whether to specific participants or to the entire meeting. Control 924 allows the participant to share content from their client device. Control 926 allows the participant to toggle recording of the meeting, and control 928 allows the participant to select an option to join a breakout room. Control 930 allows the participant to launch an app within the video conference client software, to, for example, access content to share with other participants in the video conference.

The control 922, when selected, can launch a chat application 935. The chat application includes a main chat window 937 that shows a chat history among the participants or a subset thereof. The chat application also includes a chat input control 938 that can be used to input chat messages, share images or video, choose emojis, start threads, and so on.

UI 900 includes an interruption event dialog box 950 that may be shown upon a loss of network connectivity to the video conference provider 402, a natural disaster, a civil disturbance, and so on. For example, the internal client device 408a may use network transport state to determine if the network connection is still active. Upon determining that it is not (e.g., following a timeout after sending a certain number of TCP or UDP packets), the interruption event dialog box 950 may be shown. In some examples, the loss of network connectivity may be detected by the survivable video conference coordinator 452. An indication of the loss can be sent to the internal client devices 408a. . .n which can cause the display of the interruption event dialog box 950.

The interruption event dialog box 950 includes a message 952 that alerts the user of the internal client device 408a of the loss of network connectivity to the video conference provider 402. The interruption event dialog box 950 also shows an alphanumerical meeting identifier 954 and a join token 956 (shown obscured to protect the privacy of the authentication information contained therein). Button 958 can be used to join the scheduled video conference using the techniques described herein for scheduled video conference survivability. The user experience associated with joining the video conference using the UI of the interruption event dialog box 950 can be designed with similarity to normal operations in mind to maximize connectivity in the event of an interruption event 412.

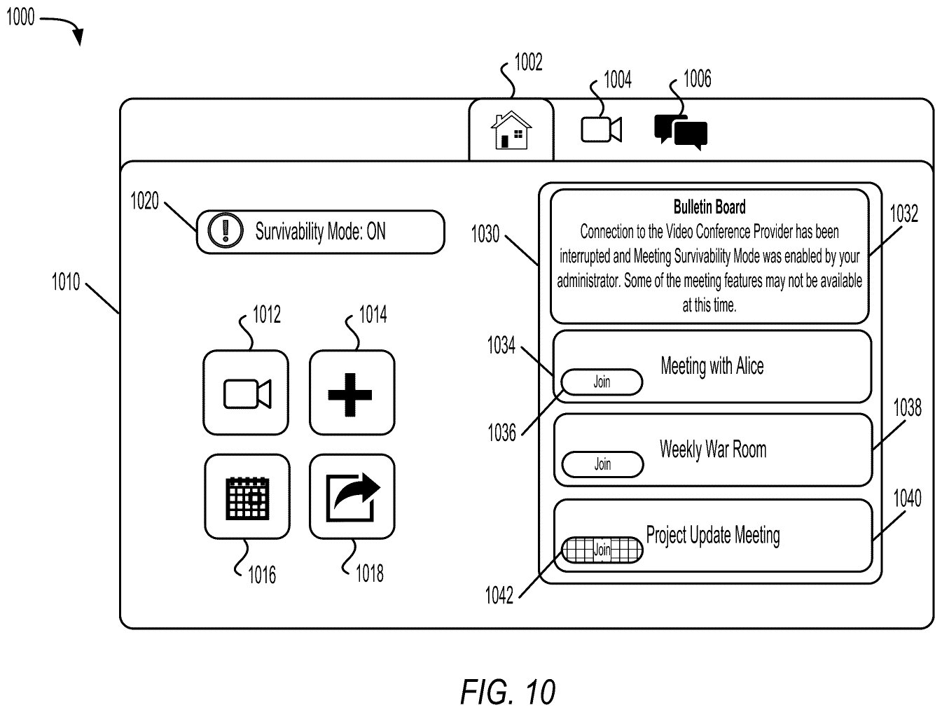

Turning next to FIG. 10, FIG. 10 shows another example of a UI 1000 as may be used in some example systems for scheduled video conference survivability, according to some aspects of the present disclosure. UI 1000 depicts a landing or home screen such as may be shown on a display device of an internal client device 408a executing video conference client software following an interruption event 412. The UI includes a home window 1010 whose selection is indicated by the highlighted home tab 1002. Other example modes operation for UI 1000 include modes selectable using the meeting tab 1004 and chat tab 1006, among others, for which similar survivable meeting controls may be shown.

Home tab 1010 includes video conference controls such as new meeting control 1012, join meeting control 1014, schedule meeting control 1016, and share content control 1018, but other controls may be shown in various other examples. A lack of a network connection to the video conference provider 402 is indicated by the survivability mode alert 1020, which may be similarly displayed on other UI screens and modes to draw attention to the alert.

Home tab 1010 includes bulletin board display 1030. For example, the survivable video conference coordinator 452 may include a web server 530 that can publish information about upcoming scheduled video conferences. The information may be viewed in a conventional web browser, but it may also be displayed in UI 1000 as shown. For example, the information shown in the bulletin board display 1030 may be retrieved from the information published by the web server 530. The bulletin board display 1030 includes an information window 1032 describing the interruption event 412 as well as a number of scheduled video conferences 1034, 1038, 1040.

Scheduled video conference 1034 includes a join button 1036 that can be selected to cause the internal client device to join the scheduled video conference, once it has begun (e.g., after the start time has passed or within a predetermined period of time preceding the start time). Scheduled video conference 1038 shows an example of a recurring, weekly scheduled video conference that will be available to the internal client devices 408a. . .n upon an interruption event without being explicitly scheduled. The join button 1042 for scheduled video conference 1040 is shown as disabled (crosshatch pattern) when the scheduled video conference 1040 is not yet available for joining.

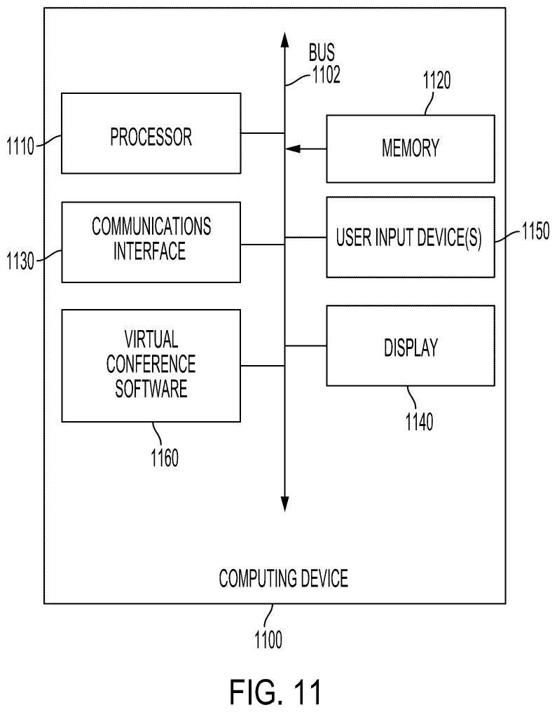

Referring now to FIG. 11, FIG. 11 shows an example computing device 1100 suitable for use in example systems or methods for providing scheduled video conference survivability, according to some examples of the present disclosure. The example computing device 1100 includes a processor 1110 which is in communication with the memory 1120 and other components of the computing device 1100 using one or more communications buses 1102. The processor 1110 is configured to execute processor-executable instructions stored in the memory 1120 to perform one or more methods for providing scheduled video conference survivability according to different examples, such as part or all of the example methods 700, 800 described above with respect to FIGS. 7 and 8. The computing device 1100, in this example, also includes one or more user input devices 1150, such as a keyboard, mouse, touchscreen, microphone, etc., to accept user input. The computing device 1100 also includes a display 1140 to provide visual output to a user.

In addition, the computing device 1100 includes virtual conferencing software 1160 to enable a user to join and participate in one or more virtual spaces or in one or more conferences, such as a conventional conference or webinar, by receiving multimedia streams from a virtual conference provider, sending multimedia streams to the virtual conference provider, joining and leaving breakout rooms, creating video conference expos, etc., such as described throughout this disclosure, etc.

The computing device 1100 also includes a communications interface 1130. In some examples, the communications interface 1130 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a method, comprising: receiving, from a video conference provider, first information about a first scheduled video conference scheduled for a first time, the first information including a first join token and a first scheduled video conference identifier; determining that a network connection to the video conference provider is not available; publishing the first information about the first scheduled video conference; receiving, from a first client device, a request to join the first scheduled video conference including the first join token and a video conference identifier; identifying the first scheduled video conference using the video conference identifier; and joining the first client device to the first scheduled video conference using the first join token.

Example 2 is the method of example(s) 1, wherein the network connection is not available due to a loss of network connectivity to the video conference provider, a natural disaster, or a civil disturbance.

Example 3 is the method of example(s) 1, wherein the first scheduled video conference is a regularly scheduled video conference scheduled for a second, recurring time.

Example 4 is the method of example(s) 1, wherein joining the first client device to the first scheduled video conference comprises: identifying a controller; outputting a first command to cause the controller to provision one or more multimedia routers for the first scheduled video conference and to initiate the first scheduled video conference using the one or more provisioned multimedia routers; outputting the first join token to the one or more provisioned multimedia routers; and outputting a second command to cause the first client device to join the first scheduled video conference by communicating with at least one of the one or more provisioned multimedia routers.

Example 5 is the method of example(s) 4, wherein the first client device, the controller, and the one or more multimedia routers are communicatively coupled using a network.

Example 6 is the method of example(s) 5, wherein the network is a wide-area network corresponding to a region.

Example 7 is the method of example(s) 5, wherein publishing the first information about the first scheduled video conference comprises outputting the first information to a web server, the web server configured to make the first information accessible as a web page to client devices using the network.

Example 8 is the method of example(s) 1, wherein determining that the network connection to the video conference provider is not available comprises: outputting one or more transport layer packets to the video conference provider; and determining whether one or more transport layer response packets are received in response within a predefined period of time.

Example 9 is the method of example(s) 1, wherein determining that the network connection to the video conference provider is not available comprises receiving an indication, from a second client device, that the network connection to the video conference provider is not available.

Example 10 is the method of example(s) 1, wherein the receiving, from the video conference provider, the first information about the first scheduled video conference occurs periodically while the network connection is available.

Example 11 is the method of example(s) 1, wherein the first join token is an alphanumeric string that encodes at least information about the first client device and a cryptographic signature.

Example 12 is a non-transitory computer-readable medium storing processor-executable instructions configured to cause one or more processors to: receive, from a video conference provider, first information about a first scheduled video conference scheduled for a first time, the first information include a first join token and a first scheduled video conference identifier; determine that a network connection to the video conference provider is not available; publish the first information about the first scheduled video conference; receive, from a first client device, a request to join the first scheduled video conference include the first join token and a video conference identifier; identify the first scheduled video conference use the video conference identifier; and join the first client device to the first scheduled video conference use the first join token.

Example 13 is the non-transitory computer-readable medium of example(s) 12, wherein the network connection is not available due to a loss of network connectivity to the video conference provider, a natural disaster, or a civil disturbance.

Example 14 is the non-transitory computer-readable medium of example(s) 12, wherein joining the first client device to the first scheduled video conference comprises: identifying a controller; outputting a first command to cause the controller to provision one or more multimedia routers for the first scheduled video conference and to initiate the first scheduled video conference using the one or more provisioned multimedia routers; outputting the first join token to the one or more provisioned multimedia routers; and outputting a second command to cause the first client device to join the first scheduled video conference by communicating with at least one of the one or more provisioned multimedia routers.

Example 15 is the non-transitory computer-readable medium of example(s) 12, wherein publishing the first information about the first scheduled video conference comprises outputting the first information to a web server, the web server configured to make the first information accessible as a web page to client devices using the network.

Example 16 is a system comprising: one or more non-transitory computer-readable media; and one or more processors communicatively coupled to the one or more non-transitory computer-readable media, the one or more processors configured to execute processor-executable instructions stored in the non-transitory computer-readable media to: receive, from a video conference provider, first information about a first scheduled video conference scheduled for a first time, the first information include a first join token and a first scheduled video conference identifier; determine that a network connection to the video conference provider is not available; publish the first information about the first scheduled video conference; receive, from a first client device, a request to join the first scheduled video conference include the first join token and a video conference identifier; identify the first scheduled video conference use the video conference identifier; and join the first client device to the first scheduled video conference use the first join token.

Example 17 is the system of example(s) 16, wherein the network connection is not available due to a loss of network connectivity to the video conference provider, a natural disaster, or a civil disturbance.

Example 18 is the system of example(s) 16, wherein joining the first client device to the first scheduled video conference comprises: identifying a controller; outputting a first command to cause the controller to provision one or more multimedia routers for the first scheduled video conference and to initiate the first scheduled video conference using the one or more provisioned multimedia routers; outputting the first join token to the one or more provisioned multimedia routers; and outputting a second command to cause the first client device to join the first scheduled video conference by communicating with at least one of the one or more provisioned multimedia routers.

19. The system of example(s) 16, wherein publishing the first information about the first scheduled video conference comprises outputting the first information to a web server, the web server configured to make the first information accessible as a web page to client devices using the network.

Example 20 is the system of example(s) 16, wherein the receiving, from the video conference provider, the first information about the first scheduled video conference occurs periodically while the network connection is available.

That which is claimed is:

1. A method, comprising:
receiving, from a video conference provider, first information about a first scheduled video conference scheduled for a first time, the first information including a first join token and a first scheduled video conference identifier;
determining that a network connection to the video conference provider is not available;
publishing the first information about the first scheduled video conference;
receiving, from a first client device, a request to join the first scheduled video conference including the first join token and a video conference identifier;
identifying the first scheduled video conference using the video conference identifier; and
joining the first client device to the first scheduled video conference using the first join token.

2. The method of claim 1, wherein the network connection is not available due to a loss of network connectivity to the video conference provider, a natural disaster, or a civil disturbance.

3. The method of claim 1, wherein the first scheduled video conference is a regularly scheduled video conference scheduled for a second, recurring time.

4. The method of claim 1, wherein joining the first client device to the first scheduled video conference comprises:
identifying a controller;
outputting a first command to cause the controller to provision one or more multimedia routers for the first scheduled video conference and to initiate the first scheduled video conference using the one or more provisioned multimedia routers;
outputting the first join token to the one or more provisioned multimedia routers; and
outputting a second command to cause the first client device to join the first scheduled video conference by communicating with at least one of the one or more provisioned multimedia routers.

5. The method of claim 4, wherein the first client device, the controller, and the one or more multimedia routers are communicatively coupled using a network.

6. The method of claim 5, wherein the network is a wide-area network corresponding to a region.

7. The method of claim 5, wherein publishing the first information about the first scheduled video conference comprises outputting the first information to a web server, the web server configured to make the first information accessible as a web page to client devices using the network.

8. The method of claim 1, wherein determining that the network connection to the video conference provider is not available comprises:
outputting one or more transport layer packets to the video conference provider; and
determining whether one or more transport layer response packets are received in response within a predefined period of time.

9. The method of claim 1, wherein determining that the network connection to the video conference provider is not available comprises receiving an indication, from a second client device, that the network connection to the video conference provider is not available.

10. The method of claim 1, wherein the receiving, from the video conference provider, the first information about the first scheduled video conference occurs periodically while the network connection is available.

11. The method of claim 1, wherein the first join token is an alphanumeric string that encodes at least information about the first client device and a cryptographic signature.

12. A non-transitory computer-readable medium storing processor-executable instructions configured to cause one or more processors to:
receive, from a video conference provider, first information about a first scheduled video conference scheduled for a first time, the first information include a first join token and a first scheduled video conference identifier;
determine that a network connection over a network to the video conference provider is not available;
publish the first information about the first scheduled video conference;
receive, from a first client device, a request to join the first scheduled video conference include the first join token and a video conference identifier;
identify the first scheduled video conference use the video conference identifier; and
join the first client device to the first scheduled video conference use the first join token.

13. The non-transitory computer-readable medium of claim 12, wherein the network connection is not available due to a loss of network connectivity to the video conference provider, a natural disaster, or a civil disturbance.

14. The non-transitory computer-readable medium of claim 12, wherein joining the first client device to the first scheduled video conference comprises:
identifying a controller;
outputting a first command to cause the controller to provision one or more multimedia routers for the first scheduled video conference and to initiate the first scheduled video conference using the one or more provisioned multimedia routers;
outputting the first join token to the one or more provisioned multimedia routers; and
outputting a second command to cause the first client device to join the first scheduled video conference by communicating with at least one of the one or more provisioned multimedia routers.

15. The non-transitory computer-readable medium of claim 12, wherein publishing the first information about the first scheduled video conference comprises outputting the first information to a web server, the web server configured to make the first information accessible as a web page to client devices using the network.

16. A system comprising:
one or more non-transitory computer-readable media; and
one or more processors communicatively coupled to the one or more non-transitory computer-readable media, the one or more processors configured to execute processor-executable instructions stored in the non-transitory computer-readable media to:
receive, from a video conference provider, first information about a first scheduled video conference scheduled for a first time, the first information include a first join token and a first scheduled video conference identifier;
determine that a network connection over a network to the video conference provider is not available;
publish the first information about the first scheduled video conference;
receive, from a first client device, a request to join the first scheduled video conference include the first join token and a video conference identifier;
identify the first scheduled video conference use the video conference identifier; and
join the first client device to the first scheduled video conference use the first join token.

17. The system of claim 16, wherein the network connection is not available due to a loss of network connectivity to the video conference provider, a natural disaster, or a civil disturbance.

18. The system of claim 16, wherein joining the first client device to the first scheduled video conference comprises:
identifying a controller;
outputting a first command to cause the controller to provision one or more multimedia routers for the first scheduled video conference and to initiate the first scheduled video conference using the one or more provisioned multimedia routers;
outputting the first join token to the one or more provisioned multimedia routers; and
outputting a second command to cause the first client device to join the first scheduled video conference by communicating with at least one of the one or more provisioned multimedia routers.

19. The system of claim 16, wherein publishing the first information about the first scheduled video conference comprises outputting the first information to a web server, the web server configured to make the first information accessible as a web page to client devices using the network.

20. The system of claim 16, wherein the receiving, from the video conference provider, the first information about the first scheduled video conference occurs periodically while the network connection is available.
